(19) United States
(12) Patent Application Publication
(10) Pub. No.: US 2009/0296759 A1
(43) Pub. Date: Dec. 3, 2009

(54) SEQUENTIALLY-MODULATED DIODE-LASER SEED-PULSE GENERATOR

(76) Inventor: Andrei Starodoumov, Cupertino, CA (US)

Correspondence Address: Coherent, Inc. c/o Morrison & Forester, 425 Market Street, San Francisco, CA, 94105-2482, US

(21) Appl. No.: 12/132,449

(22) Filed: Jun. 3, 2008

(51) Int. Cl. H01S 3/10

(52) U.S. Cl. 372/25; 372/26

(57) ABSTRACT

A modulated diode-laser provides a first sequence of optical pulses. The first sequence of optical pulses is further modulated to provide a second sequence of optical pulses. Pulses in the second sequence have a shorter duration than pulses in the first sequence.

### TECHNICAL FIELD OF THE INVENTION

The present invention relates in general to seed pulse generators in master oscillator power amplifier (MOPA) laser systems. The invention relates in particular to MOPAs in which seed pulses are generated by modulating the output of a diode-laser.

### DISCUSSION OF BACKGROUND ART

Pulsed frequency converted solid-state lasers are used extensively for material processing applications such as machining, drilling and marking. Most commercially available, pulsed, solid-state lasers are operated by the well known technique of Q-switching. Q-switched pulsed lasers include a laser-resonator having a solid-state gain-element and selectively variable-loss device located therein. The laser resonator is terminated at one end thereof by a mirror that is maximally reflecting at a fundamental wavelength of the gain-element, and terminated at an opposite end thereof by a mirror that is partially reflecting and partially transmitting at the fundamental wavelength. Such a laser is usually operated by continuously optically pumping the gain element while periodically varying (switching) the loss caused by the variable loss device (Q-switch) between a value that will prevent lasing in the resonator and a value that will allow lasing in the resonator. While lasing is allowed in the resonator, laser radiation is delivered from the partially transmitting mirror as a laser pulse.

The pulse repetition frequency (PRF) of a Q-switched solid-state laser is determined by the frequency at which the Q-switch is switched. The pulse duration is determined for any particular gain-medium by factors including the transmission of the partially-transmitting mirror, any loss in the Q-switch in a lasing-allowed condition, the optical pump power, and the PRF. A pulse repetition rate and pulse duration that are optimum for an operation on any one material will usually not be optimum for another operation or another material. Accordingly, an “ideal” pulsed laser would have independently variable PRF and pulse-duration to allow an optimum combination to be selected for most operations on most materials.

One type of laser system in which the PRF can be varied without a variation in pulse duration is an optical-fiber based MOPA in which seed pulses are generated by a modulated single-mode, edge-emitting semiconductor laser diode-laser. High gain per a fiber amplification stage, for example between about 13 and 30 decibels (dB), together with a low saturation power allows using a variety of low power diode seed sources. Such a fiber MOPA can be operated at pulse-repetition frequencies (PRFs) from less than 100 kilohertz (kHz) to 5 megahertz (MHz) or greater with pulse duration selected between about 0.1 nanosecond (ns) and about 1 microsecond (its).

A major problem with fiber MOPAs is due to nonlinear effects that limit peak power and adversely affect spectral characteristics of the optical pulses. For harmonic generation from nanosecond pulses spectrally narrow light having a bandwidth of between about 0.5 nanometers (nm) and 1 nm is required. Stimulated Raman scattering (SRS), stimulated Brillouin scattering (SBS), and spectral-broadening of nanosecond pulses due to four-wave mixing (FWM) in fibers significantly narrow the available space of optical parameters acceptable for frequency conversion.

There are two approaches to generation of pulses with variable length and pulse repetition rate. The first approach uses directly modulated diode-lasers as a seed source. Such an approach is in general less expensive, and provides high peak power (above 1 W) from the seed laser. A major disadvantage of this approach is that in order to provide short pulses of less than 10 ns, a short cavity length, for example less than about 10 mm is required. This, in turn, results in a single-frequency or a few frequency mode operation that favors to SBS and limits a peak power in fiber amplifiers. Another problem of few-frequency mode operation is a strong mode-beating effect resulting in significant pulse-to-pulse fluctuations. For longer cavity lengths, for example between about 10 centimeters (cm) and 30 cm, the pulse spectrum changes across an optical pulse at it comes to a steady state spectral width after many round-trips, for example between about 3 and 8 round trips. That is why at direct diode modulation with long cavities, an optical pulse has a spectral width narrowing toward the end of the pulse.

A second approach uses a continuously operating (CW) optical source modulated by an external modulator. In such an approach, a seed-source could be a diode laser, a solid-state laser, or a fiber laser. Typical modulators include an electro-optical crystal in a waveguide Mach-Zehnder configuration or a diode-laser amplifier. On one hand, such an approach provides less peak power, typically less than 100 milliwatts (mW) after modulation compared to a directly modulated diode-laser. On the other hand this approach allows pulses of any length and repetition rate to be generated with a spectrum determined by an appropriately designed seed-laser such as a low-noise seed laser. By way of example, a diode seed-laser having low-noise operation can be realized by incorporating a fiber Bragg grating (FBG) in a long fiber coupled to a diode-laser chip, with the FBG between about 1 meter (m) and 2 m from the diode-laser chip to form a cavity including the chip. The FBG provides an output coupler for the cavity.

A problem with such a MOPA is that between seed pulses there is a very low but finite CW background emission from the diode laser, for example between about 20 dB and 30 dB less than pulse peak power. A typical electro-optical waveguide modulator based on Mach-Zehnder waveguide in a lithium niobate (LiNbO₃) crystal has a contrast ratio of between about 18 dB and 25 dB. While on first consideration this may seem insignificant it must be recognized that the background exists considerably longer than the pulses. By way of example, for pulses having a duration of 1 ns at a PRF of 100 KHz the background duration is ten-thousand times longer than the pulse duration.

The background level between pulses is amplified in the power amplifier in addition to the pulses being amplified. Amplifying the background takes energy from whatever gain medium is used in the amplifier. This reduces the efficiency of amplification of the pulses and results in a relatively low contrast ratio (ratio of pulse-intensity and background-intensity) in the amplified output. There is need for improving the efficiency of amplification and increasing the output contrast-ratio in diode-laser seeded MOPAs.

### SUMMARY OF THE INVENTION

In one aspect, apparatus in accordance with the present invention comprises a diode-laser arrangement arranged to provide a first sequence of optical pulses, the pulses in the first sequence thereof having a first duration. A modulator arrangement is provided for modulating the first sequence of optical pulses to provide a second sequence of optical pulses. The pulses in the second sequence thereof have a second duration, the second duration being shorter than the first duration.

In one embodiment of the inventive apparatus, the diode-laser arrangement includes a diode-laser driven by a first sequence of current pulses such that the output of the diode-laser is the first sequence of optical pulses. The modulator arrangement may include a modulated semiconductor optical amplifier or an electro-optic modulator. In another embodiment of the inventive apparatus, the diode-laser arrangement includes a first diode-laser arranged to provide continuous wave (CW) radiation and a semiconductor optical amplifier arranged to modulate the CW radiation to provide the first sequence of optical pulses.

### BRIEF DESCRIPTION OF THE DRAWINGS

The accompanying drawings, which are incorporated in and constitute a part of the specification, schematically illustrate a preferred embodiment of the present invention, and together with the general description given above and the detailed description of the preferred embodiment given below, serve to explain principles of the present invention.

FIG. 1 schematically illustrates one preferred embodiment of a MOPA in accordance with the present invention having a seed pulse generator including a directly modulated external-cavity diode-laser the providing output pulses of a first duration which are further modulated by a double-pass semiconductor optical amplifier to produce pulses of a second duration shorter than the first duration with the second-duration pulses being directed to a power amplifier.

FIGS. 2A-C are graphs schematically illustrating the first-duration pulses of the directly modulated external-cavity diode-laser being further modulated by the double-pass semiconductor optical amplifier to provide corresponding second-duration pulses for delivery to the power amplifier in the MOPA of FIG. 1.

FIG. 3 schematically illustrates another preferred embodiment of a MOPA in accordance similar to the MOPA of FIG. 1 but wherein the semiconductor optical amplifier is replaced by a double-pass E-O modulator.

FIG. 4 schematically illustrates yet another preferred embodiment of a MOPA in accordance with the present invention having a seed pulse generator including a CW external-cavity diode-laser the output of which is modulated by a double-pass semiconductor optical amplifier to provide pulses of a first duration, the seed pulse generator further including a double-pass E-O modulator arranged to modulate the first-duration pulses to produce pulses of a second duration shorter than the first duration, with the second-duration pulses being directed to a power amplifier.

### DETAILED DESCRIPTION OF THE INVENTION

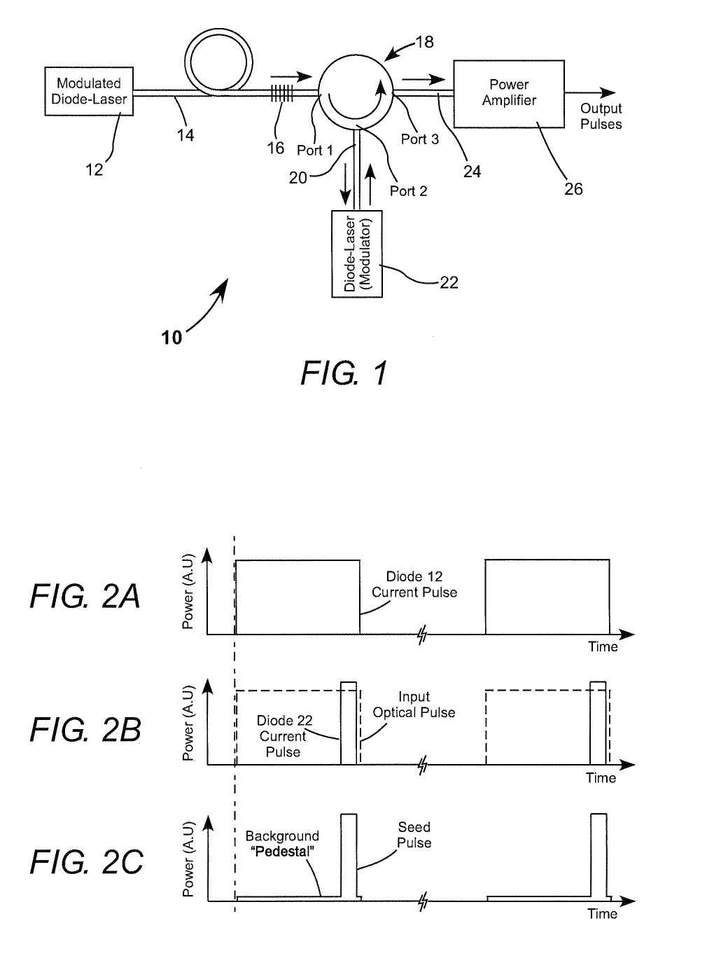

Referring now to the drawings, wherein like components are designated by like reference numerals, FIG. 1 schematically illustrates one preferred embodiment 10 of a MOPA in accordance with the present invention. MOPA 10 includes a directly modulated diode-laser 12 having an external cavity formed by a length of optical fiber 14 and terminated by a fiber Bragg grating (FBG) 16 written into the core of the length of optical fiber. Preferably the diode-laser is a single mode diode-laser and the length of optical fiber is a length of single-mode optical fiber. The FBG serves to wavelength-lock the diode-laser output and the long cavity provided by the optical fiber and the FBG provides for spectrally narrowing the output bandwidth. The FBG is partially transmissive for delivering pulses from the laser cavity.

The term “directly modulated” as used here with reference diode-laser 12 means that the diode-laser is driven by a pulsed electric current. The output (from FBG 16) of the extended cavity diode-laser is a sequence of radiation pulses having about the form of the driving-current pulses. The fastest rise-time is determined by diode-laser package design and typically varies from about 100 picoseconds (ps) to about 5 ps. For longer cavity lengths, for example between about 1 m and 2 m, between about 3 and 8 round trips (between about 30 ns and 160 ns) are required to establish a pulse bandwidth determined by the FBG. The pulses preferably have a duration between about 300 ns and 500 ns, so at the end of the pulse, the pulse spectral-width corresponds to a steady-state spectrum.

The pulses enter a circulator 18 via port-1 thereof and exit the circulator via port-2 thereof to be transported by an optical fiber 20 to a diode-laser 22, here arranged as a semiconductor optical amplifier. Diode-laser 22 is also driven by a pulsed electric current, wherein the current pulses are of a shorter duration than the current pulses driving diode-laser 12 and determine the duration of output pulses of the MOPA. Preferably the pulses have a duration between about 1 ns and 100 ns. The PRF of current pulses driving diode-laser 22 is exactly the same as the PRF of the current pulses driving diode-laser 12. The current pulses driving diode-laser 22 are synchronized to occur within the period of an optical pulse entering diode-laser 22. Diode-lasers 12 and 22 preferably have the same peak-gain wavelength.

This situation is illustrated schematically in FIGS. 2A, 2B and 2C. FIG. 2A depicts optical pulses (power as a function of time) resulting from pulsed-current driving of diode-laser 12. The break symbol on the time-axis indicates that the period between pulses is very much longer than the pulse duration. FIG. 2B illustrates a current pulse being applied to diode-laser 22 during a portion of the period of an optical pulse (dashed curve) making forward and reverse passes in the diode-laser. While current is applied to the diode-laser the diode-laser functions an amplifier. When current is not applied to diode-laser 22, the diode-laser functions as an absorber at the wavelength of the optical pulses, such that the diode-laser 22 effectively functions as a modulator that amplitude modulates (chops) the already modulated output of diode-laser 12.

FIG. 2C schematically illustrates the form of the output of diode-laser 22. This includes an initial “pedestal” portion, which is the portion of an input pulse that is not completely absorbed and a subsequent signal portion, of relatively short duration, which is effectively a seed-pulse. The level of the pedestal portion compared with the pulse portion is exaggerated in FIG. 2C for convenience of illustration. The inter-pulse background from diode-laser 12 is attenuated by absorption in diode-laser 22 to an insignificant level. The background in the output of diode-laser 22 is contained essentially in the pedestal portions of output pulses and can be proportionately between about 1 and 3 orders of magnitude less than the background in the output of diode-laser 12.

Continuing now with reference again to FIG. 1, the combination of the diode-lasers 12 and 22, operating as described above, can be regarded as a seed-pulse generator. Output of diode-laser 22, i.e., output of the seed pulse generator, is delivered, via a return pass along optical fiber 20, to port 2 of circulator 18 and exits the circulator via port 3 thereof. An optical fiber 24 transports the output of the circulator to a power amplifier 26. Power amplifier 26 is depicted in FIG. 1 in functional block form only. The power amplifier can have any configuration without departing from the spirit and scope of the present invention. By way of example, the power amplifier can have one stage or a plurality of stages of optical fiber amplification. The power amplifier can also have one or more stages of bulk amplification, or a combination of fiber and bulk amplification stages.

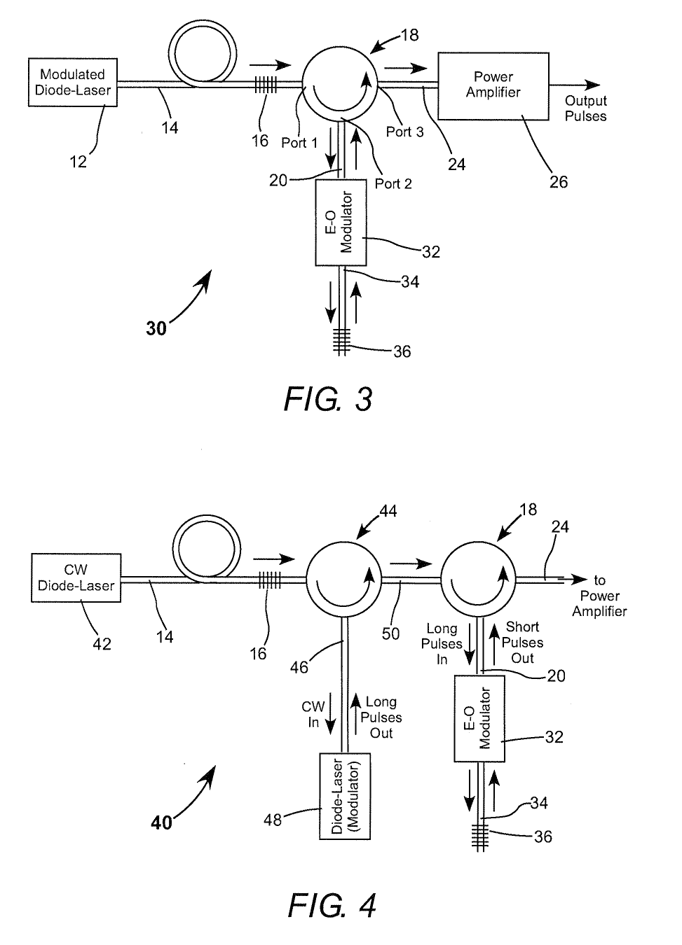

FIG. 3 schematically illustrates another preferred embodiment 30 of a MOPA in accordance with the present invention. MOPA 30 is similar to MOPA 10 of FIG. 1 with an exception that the diode-laser modulator 22 of laser 10 is replaced in laser 30 by an electro-optic (E-O) modulator 32 having an optical fiber 34 connected thereto with fiber 34 having a FBG 36 written into the core thereof. FBG 36 is preferably maximally reflective at the wavelength of the diode-laser pulses being modulated. One preferred form of E-O modulator for modulator 32 is a planar-waveguide Mach-Zehnder (MZ) E-O modulator formed in a lithium niobate (LiNbO₃) crystal. Pulses transported by fiber 20 from circulator 18 are modulated once in a forward pass through the modulator, are reflected from FGB 36 and modulated again on a reverse pass through the E-O modulator. The output of E-O modulator 32 is transported to a power amplifier as described above with reference to laser 10 of FIG. 1.

Typically an E-O modulator for operation at about 1000 nm wavelength is at least two times more expensive than a diode-laser. However, an E-O modulator provides sharper edges of an optical pulse since its rise time is typically between about 100 ps and 300 ps. A diode-laser provides simultaneous gain and modulation functions while an E-O modulator introduces high insertion loss, for example between about 4 and 6 dB. To compensate for this loss, fibers 20 or 34 can be or include gain fibers. Gain fibers will, however, require corresponding pump-diode lasers (not shown).

FIG. 4 schematically illustrates yet another preferred embodiment 40 of a MOPA in accordance with the present invention. MOPA 40 is similar to MOPA 30 of FIG. 3 with an exception that directly modulated diode-laser 12 of laser 30 is replaced in laser 40 by a CW diode-laser 42 having an extended cavity formed by optical fiber 14 and FBG 16 therein as described above with reference to laser 10. CW radiation is output through FBG 16, enters a circulator 44 exits and the circulator along a fiber 46 which transports the CW radiation to a directly modulated diode-laser 48. Diode-laser 48 is operated to provide, from the input CW radiation, the long duration pulses corresponding to those pulses that are provided by directly modulated diode-laser 12 in MOPA 10 and in MOPA 30. The output of the modulator returns via fiber 46 to circulator 44 and is transported from circulator 44 to circulator 18 by an optical fiber 50, for further modulation as described above.

In each of the embodiments of the present invention described above there are two stages of modulation with at least one stage of modulation being in a double-pass configuration. The first stage of modulation provides pulses of a relatively long duration. These pulses are modulated in the second stage of modulation to provide pulses of a shorter duration. Those skilled in the art will recognize that it possible to include, without departing from the spirit and scope of the present invention, more than two modulation stages, in single or double-pass configuration, with pulses being of shorter duration after each stage.

In summary, present invention is described above in terms of a preferred and other embodiments. The invention is not limited, however, to the embodiments described and depicted. Rather, the invention is defined by the claims appended hereto.

What is claimed is:

1. Optical apparatus, comprising:
a diode-laser arrangement arranged to provide a first sequence of optical pulses, the pulses in the first sequence thereof having a first duration; and
a modulator arrangement for amplitude modulating the first sequence of optical pulses to provide a second sequence of optical pulses, the pulses in the second sequence thereof having a second duration, the second duration being shorter than the first duration.

2. The apparatus of claim 1, wherein the first duration is between about 300 and 500 nanoseconds and the second duration is between about 1 and 100 nanoseconds.

3. The apparatus of claim 1, wherein the diode-laser arrangement includes a diode-laser driven by a first sequence of current pulses such that the output of the diode-laser is the first sequence of optical pulses.

4. The apparatus of claim 3, wherein the modulator arrangement includes a modulated semiconductor optical amplifier.

5. The apparatus of claim 3, wherein the modulator arrangement includes an electro-optic modulator.

6. The apparatus of claim 1, wherein the diode-laser arrangement includes a first diode-laser arranged to provide continuous wave (CW) radiation and a semiconductor optical amplifier arranged to modulate the CW radiation to provide the first sequence of optical pulses.

7. The apparatus of claim 3, wherein the modulator arrangement includes an electro-optic modulator.

8. Optical apparatus, comprising:
a first diode-laser arranged to provide a first sequence of optical pulses, the pulses in the first sequence thereof having a first duration; and
a second diode-laser arranged to amplitude modulate the first sequence of optical pulses to provide a second sequence of optical pulses, the pulses in the second sequence thereof having a second duration, the second duration being shorter than the first duration.

9. The apparatus of claim 8, wherein the first duration is between about 300 and 500 nanoseconds and the second duration is between about 1 and 100 nanoseconds.

10. The apparatus of claim 8, wherein the first diode-laser is optically connected via a first optical fiber to the first port of a circulator having first, second and third ports, the second port of the circulator is optically connected via a second optical fiber to the second diode-laser such that the first sequence of pulses enters the first port of the circulator, exits the second port of the circulator, is amplitude modulated on forward and reverse passes through the second diode-laser to provide the second sequence of optical pulses, the second sequence of optical pulses is transported by the second optical fiber to the circulator and exits the circulator via the third port thereof.

11. The apparatus of claim 8, further including a power amplifier for amplifying the second sequence of optical pulses.

12. Optical apparatus, comprising
a diode-laser arranged to provide a first sequence of optical pulses, the pulses in the first sequence thereof having a first duration and a wavelength; and
an electro-optic modulator arranged to amplitude modulate the first sequence of optical pulses to provide a second sequence of optical pulses, the pulses in the second sequence thereof having a second duration, the second duration being shorter than the first duration.

13. The apparatus of claim 12, wherein the first duration is between about 300 and 500 nanoseconds and the second duration is between about 1 and 100 nanoseconds.

14. The apparatus of claim 12, wherein first diode-laser is optically connected via a first optical fiber to the first port of a circulator having first second and third ports; the second port of the circulator is optically connected via a second optical fiber to one side of an electro-optic modulator; a third optical fiber is connected to an opposite side of the electro-optic modulator, the third optical fiber including a fiber Bragg grating reflective at the wavelength of the pulses from the diode-laser; and wherein the first sequence of pulses enters the first port of the circulator, exits the second port of the circulator, is modulated on a forward pass through the electro-optic modulator is transported through the third optical fiber to the fiber Bragg grating and is reflected therefrom back through the third optical fiber, and is modulated again by the electro-optic modulator to provide the second sequence of optical pulses, the second sequence of optical pulses being transported by the second optical fiber to the circulator and exiting the circulator via the third port thereof.

15. The apparatus of claim 14, wherein the electro-optic modulator is a waveguide Mach-Zehnder modulator.

16. The apparatus of claim 14, wherein the third optical fiber is an optical gain fiber.

17. Optical apparatus, comprising
a first diode-laser arranged to provide continuous-wave radiation the radiation having a wavelength;
a second diode-laser arranged to amplitude modulate the CW radiation thereby providing a first sequence of optical pulses, the pulses in the first sequence thereof having a first duration; and
an electro-optic modulator arranged to amplitude modulate the first sequence of optical pulses to provide a second sequence of optical pulses, the pulses in the second sequence thereof having a second duration, the second duration being shorter than the first duration.

18. The apparatus of claim 16, wherein the first duration is between about 300 and 500 nanoseconds and the second duration is between about 1 and 100 nanoseconds.

19. The apparatus of claim 16, wherein first diode-laser is optically connected via a first optical fiber to the first port of a first circulator having first, second and third ports; the second port of the first circulator is optically connected via a second optical fiber to the second diode-laser; the third port of the first optical circulator is optically connected to the first port of a second optical circulator having first second and third ports by a third optical fiber; the second port of the second optical circulator is optically connected to one side of the electro-optic modulator by a fourth optical fiber and an opposite side of the electro-optic modulator is connected to a fifth optical fiber including a fiber Bragg grating reflective at the wavelength of the radiation from the first diode-laser; and wherein the radiation from the first diode-laser enters the first port of the first optical circulator, exits the second port of the first optical circulator and is amplitude modulated on forward and reverse passes through the second diode-laser to provide the first sequence of optical pulses, the first sequence of pulses enters the second port of the first optical circulator, exits the first optical circulator via the third port thereof, enters the first port of the second optical circulator, exits the second port of the second optical circulator, is amplitude modulated on a forward pass through the electro-optic modulator, is transported through the fifth optical fiber to the fiber Bragg grating and is reflected therefrom back through the fifth optical fiber, and is amplitude modulated again by the electro-optic modulator to provide the second sequence of optical pulses, the second sequence of optical pulses being transported by the fourth optical fiber to the second optical circulator and exiting the second optical circulator via the third port thereof.

20. A method of generating a train of optical pulses comprising the steps of:
generating a first sequence of optical pulses by modulating the power supplied to a diode laser, said pulses in the first sequence having a first duration; and
amplitude modulating the first sequence of optical pulses to create a second sequence of optical pulses having the same pulse repetition frequency and a shorter duration than the pulses of the first sequence.

21. A method as recited in claim 20, wherein said amplitude modulating step is performed by passing the first sequence of pulses through a modulated semiconductor amplifier.

22. A method as recited in claim 20, wherein said amplitude modulating step is performed by passing the first sequence of pulses through an electro-optic modulator.

23. A method as recited in claim 20, further including the step of amplifying the second sequence of optical pulses in a power amplifier.
